(19) United States
(12) Patent Application Publication
(10) Pub. No.: US 2010/0001445 A1
(43) Pub. Date: Jan. 7, 2010

(54) VIBRATION ISOLATOR

(75) Inventors: Teruo Maruyama, Hirakata-shi (JP); Masashi Yasuda, Suita-shi (JP)

Correspondence Address: ALLEMAN HALL MCCOY RUSSELL & TUTTLE LLP, 806 SW BROADWAY, SUITE 600, PORTLAND, OR, 97205-3335, US

(73) Assignee: TOKKYOKIKI CORPORATION, Amagasaki-city (JP)

(21) Appl. No.: 12/495,146

(22) Filed: Jun. 30, 2009

(30) Foreign Application Priority Data
Jul. 1, 2008 (JP) 2008-172817

(51) Int. Cl. F16F 9/02

(52) U.S. Cl. 267/113

(57) ABSTRACT

There is provided a vibration isolator capable of, (1) vibration isolation performance for ground motion disturbance: vibration isolation for floor vibration, and (2) vibration control performance for direct acting disturbance: suppression of swing due to driving reaction force caused by stage movement, significantly improving the above (2), i.e., the vibration control performance, with keeping the above (1), i.e., the vibration isolation performance, at a high level.

### FIELD OF THE INVENTION

The present invention relates to a vibration isolator or the like used for installation of precision equipment such as a semiconductor manufacturing apparatus or precision measuring equipment, and belongs to the field of vibration control that reduces vibration by controlling an inner pressure of a pneumatic spring supporting such a vibration isolating object.

### BACKGROUND

In various fields such as semiconductor manufacturing, liquid crystal manufacturing, and precision machining, the use of vibration control for shielding/suppressing micro vibration is widely spread. In a microfabrication/inspection apparatus such as a scanning electron microscope, or a semiconductor exposure system (stepper) used in such a process, a strict vibration allowable condition for ensuring performance of the apparatus is required. For the future, there is a trend in which along with further advances in integration degree/miniaturization of a product, increases in speed of a fabrication process and size of apparatus are promoted, and the vibration allowable condition becomes stricter.

Disturbance to be removed in a vibration isolator is roughly classified into ground motion disturbance caused by vibration of an installation floor, and direct acting disturbance inputted onto a vibration isolation table.

Sources of the vibration causing the ground motion disturbance include one due to the movement of persons, which is called walk vibration having a vibration frequency of approximately 1 to 3 Hz, one due to a motor of an air conditioner or the like, which has a vibration frequency of approximately 6 to 35 Hz, and one due to resonance of a building or earthquake, which has a vibration frequency of approximately 0.1 to 10 Hz. A skyscraper/seismic isolated building has a natural frequency near 0.2 to 0.3 Hz. Also, due to wind, micro vibration having a vibration frequency of 0.1 to 1.0 Hz occurs in a building. Accordingly, the vibration isolation table is required not only to suppress high frequency vibrations but to remove such low frequency vibrations.

In the case where, for example, a positioning stage is mounted on the vibration isolation table as a source of the vibration due to the direct acting disturbance, a structure including the vibration isolation table receives blows from acceleration/deceleration driving of the stage, and swings due to driving reaction force. The vibration due to the blows and the swing caused by the driving reaction force should be suppressed for maintaining performance of the stage.

In summary, the vibration isolator is required to have a function of both “vibration isolation” for the ground motion disturbance and “vibration control” for the direct acting disturbance.

FIG. 21 illustrates a model diagram of a conventional active vibration isolation table using a pneumatic actuator. The active vibration isolation table is publicly known as described in Japanese Unexamined Patent Publication Nos. 2006-283966 and 2007-155038. On a floor surface 100, a plurality of sets of pneumatic actuators (102a and 102b) for supporting a platen 101 are arranged. Precision equipment (not shown) is mounted on the platen 101. Any of the pneumatic actuators (hereinafter described with 102a) includes: an air chamber 103 inside which high pressure air for supporting a vertical load is filled; and a piston 105 inserted inside an upper part of the air chamber 103 through a diaphragm 104. Reference numerals 106, 107a, and 107b represent an acceleration sensor for detecting vertical and horizontal accelerations of the platen 101, and displacement sensors for detecting relative displacements of the platen 101 relative to the floor surface 100, respectively. Reference numeral 108 represents an acceleration sensor for detecting an acceleration (fundamental vibrational state) of the floor surface 100. Output signals from the respective sensors are inputted to a controller 109. The air chamber 103 is connected, through a tube 110, with a servo valve 111 for controlling an inner pressure of the air chamber 103.

The pneumatic actuator is poor in responsiveness as compared with a piezo actuator, an ultra-magnetostrictive actuator, or a linear motor; however, it is advantageous in heat generation and leakage magnetic flux, and also the actuator itself has an effect of isolating vibration from the floor surface (vibration isolation performance) because of compressibility of the air. Also, by controlling a pneumatic spring pressure, vibration control of the direct acting disturbance can be performed. That is, a feature of the pneumatic type is that the pneumatic type can have both of the “vibration isolation” and “vibration control”, which is absent in an actuator of any other type. Along with a trend of increasing equipment in size supported by the vibration isolation table, a pneumatic spring type vibration isolation table utilizing the advantage of the pneumatic actuator becomes widely used for micro vibration control for ultra precision equipment.

### SUMMARY OF THE INVENTION

In recent years, performance required for a vibration isolation table used for a semiconductor manufacturing apparatus, or an inspection system has been increasingly improved along with the advance in integration degree of a product. For example, in the field of semiconductor, mass production with a line width of 65nm is already possible, and a natural frequency of a pneumatic spring used for a stepper that is a manufacturing apparatus for the mass production is 2 Hz or less. However, for further advances in integration degree and miniaturization, the achievement of a flexible spring having a smaller natural frequency is required. By a measure such as an increase in volume of an air chamber, or the use of a sub tank in order to reduce stiffness of a pneumatic spring of a pneumatic actuator, a vibration isolation effect (vibration isolation performance) for the ground motion disturbance can be improved. However, as a result, responsiveness of the actuator is reduced, and therefore there arises a problem that a vibration suppression effect is reduced for the direct acting disturbance caused by the mass transfer of a stage (112 in FIG. 21) mounted on the vibration isolation table, which contradicts the improvement of the vibration isolation performance. The mounted stage is getting larger and faster in recent years to improve productivity, and therefore achievement of quicker vibration control and position control is required for the vibration isolation stage.

As is well known, the vibration isolation and vibration control performances of equipment can be improved by the selection and device (synthesis) of a control system for a controlled object, such as velocity, acceleration, pressure, or pressure derivative feedback or feedforward. For example, an application of the acceleration feedback (using the acceleration sensor 106 in FIG. 21) is equivalent to an increase in mass m, and therefore effects of reducing a natural frequency, resonant peak, and the like can be obtained although depending on a condition. If the signal from the ground motion acceleration sensor (108 in FIG. 21) arranged just below the platen 101 is used to apply the feedforward, the vibration isolation performance can be significantly improved in a wide frequency range.

FIG. 22 is a graph schematically illustrating the vibration isolation performance of a vibration isolator using a pneumatic actuator. Graphs a, b, and c in the diagram are ones for the case where proportional displacement feedback is only applied, and a volume of an air chamber, and a resonant frequency decreases and increases, respectively, in the order of a, b, and c. Graphs a′, b′, and c′ are ones for the case where the vibration isolation performance is improved for actuators corresponding to the above a, b, and c by selecting a control system. That is, the graphs a′, b′, and c′ are illustrated for the case where in addition to the proportional displacement feedback, the acceleration feedback (above-described (1)) and the ground motion acceleration feedforward (above-described (2)) are applied. If the actuator corresponding to the graph a is selected to obtain better vibration isolation performance, the improvement effect on the vibration isolation performance has a limitation as indicated by the graph a′. On the other hand, if the characteristic of the graph c′ is selected to obtain better vibration isolation performance, the actuator corresponding to the graph c, which has the largest air chamber volume, should be selected, and therefore the vibration isolation performance has a limitation.

In summary, even if the selection and device of a control system is performed, there is a tradeoff relationship between the vibration isolation performance for the ground motion disturbance, and the vibration control performance for the direct acting disturbance, and therefore it is conventionally difficult to simultaneously achieve excellent performance for the both.

The present invention is one in which in the following basic performances of a pneumatic actuator type vibration isolator, which are conventionally the two contradict each other, that is, (1) vibration isolation performance for ground motion disturbance: vibration isolation for floor vibration, and (2) vibration control performance for direct acting disturbance: suppression of swing due to driving reaction force caused by stage movement, the presence of a condition for significantly improving the above vibration control performance (2) while keeping the above vibration isolation performance (1) at a high level is first theoretically found out by introducing a concept of dynamic stiffness, i.e., “a stiffness of a pneumatic spring varies depending on a frequency”. That is, by setting an actuator outer diameter, supply source pressure, control valve flow rate, air chamber volume inside an actuator, and the like to values that are independent of specifications conventionally considered common-sense for actuators, and combining them, the presence of a range in which an absolute value and phase of the pneumatic spring stiffness are largely varied depending on the frequency is clarified by extensive examinations carried out by the present inventor. In the present invention, this frequency range is referred to as a “dynamic stiffness transition range”.

In summary of an effect of an invention according to Claim 1, by introducing the new concept of the dynamic stiffness transition range, which is conventionally absent, and configuring an actuator with focusing on the dynamic stiffness transition range, a dynamic stiffness of a pneumatic spring can be set to a lower value than a stiffness of a conventional actuator, and therefore a flexible spring can be provided. In the dynamic stiffness transition range, “parameter selection is in the same direction” to provide the flexible pneumatic spring and improve responsiveness, and there is no contradiction relationship, differently from the conventional case. For this reason, the vibration control performance can be significantly improved with the vibration isolation performance being kept at a high level. Further, in the dynamic stiffness transition range, a phase of the dynamic stiffness moves in a plus direction, so that a resonant condition that should be determined by a mass and an impedance of a spring is not met, and therefore a resonant peak is largely suppressed.

In summary of an effect of an invention according to Claim 2, a basic condition for completing the present invention is defined with use of: the static stiffness k₀; the resonant frequency f₀ (Hz); and the dynamic stiffness absolute value |K_{d}(f₀)| of the pneumatic spring at a resonant point, which are basic characteristics of the pneumatic spring. According to the present invention, without recognizing detailed parameters of respective factors constituting a vibration isolator, and an operating state including a pressure, a flow rate, and the like, the fact that the resonant frequency is set in the dynamic stiffness transition range, or a lower frequency range than the dynamic stiffness transition range can be verified also in an experimental manner.

In summary of an effect of an invention according to Claim 3, the theoretically found dynamic stiffness parameter γ, and a dimensionless dynamic stiffness K_{do} (Equation 1), which is a function of γ and a frequency f, are important evaluation indices in determining a condition for configuring the actuator, which effectively completes the present invention. If a load mass supported by the vibration isolator is determined, a design parameter of the pneumatic spring to which the present invention can be applied under the best condition can be specifically and easily selected.

In summary of an effect of an invention according to Claim 4, even in the case of treating the vibration isolator as a black box, the dynamic stiffness parameter γ, which is the important evaluation index in recognizing the basic performances of the actuator, can be experimentally obtained.

In summary of an effect of an invention according to Claim 5, a range of a condition under which the present invention is effectively utilized can be clearly determined from economic and performance aspects.

An effect of an invention according to Claim 6 is to be able to support a higher load mass, as compared with the above-described vibration isolator including the pneumatic spring alone.

An effect of an invention according to Claim 7 is to be able to more extensively select, in consideration of an improvement of the vibration isolation performance upon use of the pneumatic spring and the auxiliary actuator in combination, a design specification of the pneumatic spring in which the present invention is utilized.

An effect of an invention according to Claim 8 is that the presence of a condition under which by driving a vacuum actuator with keeping gas flowing during a stationary period, the dynamic stiffness parameter γ and resonant frequency can be made larger and smaller, respectively, is found out. By applying the present invention, performance that can suppress the resonant peak, and achieve both of the excellent vibration isolation performance and the vibration control performance can be obtained.

By applying the present invention, a precision vibration isolation table capable of obtaining high vibration control performance with keeping excellent vibration isolation performance can be provided. That is, vibration control performance may be improved. For example, along with increases in size and speed of a stage mounted on the vibration isolation table, an increase in excitation force including a high frequency component can be responded to. Also, vibration isolation performance may be improved. For example, floor vibration isolation performance can be improved for advances in integration level and miniaturization of a product by a more flexible spring. A request for the vibration isolation table capable of achieving both of the above performance improvements in the best condition can be responded to. A corresponding effect is extraordinary.

### BRIEF DESCRIPTION OF THE DRAWINGS

FIG. 1 is a model diagram of a precision vibration isolator illustrating a first embodiment 1 of the present invention;

FIG. 2 is a graph of an analysis result in which vibration isolation performances of the present invention and conventional example are compared;

FIG. 3 is a graph of an analysis result in which transient response characteristics of the present invention and conventional example are compared;

FIG. 4 is a graph of an analysis result in which frequency response characteristics of the present invention and conventional example are compared;

FIG. 5 is a graph of an analysis result of the present invention in which vibration isolation performances are compared with a valve flow rate being varied;

FIG. 6 is a graph of an analysis result of the present invention in which transient responses are compared with the valve flow rate being varied;

FIG. 7 is a graph of an analysis result of the conventional example in which vibration isolation performances are compared with a valve flow rate being varied;

FIG. 8 is a graph of an analysis result of the conventional example in which transient responses are compared with the valve flow rate being varied;

FIG. 9 is a model diagram for analyzing a pneumatic actuator;

FIG. 10 is a graph illustrating a relationship between an absolute value of a dimensionless dynamic stiffness and a frequency;

FIG. 11 is a graph illustrating a relationship between a phase of the dimensionless dynamic stiffness and the frequency;

FIG. 12 is a diagram illustrating a relationship between the dimensionless dynamic stiffness and the frequency, which defines a dynamic stiffness transition range;

FIG. 13 is a diagram illustrating a relationship between the absolute value of the dimensionless dynamic stiffness and a dynamic stiffness parameter;

FIG. 14 is a model diagram of a precision vibration isolator illustrating a second embodiment of the present invention;

FIG. 15 is a graph of an analysis result in which the present example and a pneumatic spring alone are compared in vibration isolation performance;

FIG. 16 is a graph of an analysis result in which the present example and the pneumatic spring alone are compared in transient response;

FIG. 17 is a graph of an analysis result in which time variations of pressures of air chambers A and B in the present example are illustrated;

FIG. 18 is graph of an analysis result in which transient response characteristics are compared with a load share ratio being varied in the present example;

FIG. 19 is a graph of an analysis result in which the present example and the pneumatic spring alone are compared in vibration isolation performance;

FIG. 20 is a graph of an analysis result in which the present example and the pneumatic spring alone are compared in transient response;

FIG. 21 is a model diagram of a conventional active precision vibration isolator mounted with a pneumatic actuator; and

FIG. 22 is a graph illustrating vibration isolation performance of a conventional vibration isolator mounted with the pneumatic actuator.

### DESCRIPTION OF THE PREFERRED EMBODIMENTS

The present invention will hereinafter be described on the basis of the following steps: [1] A principle and a basic structure of a precision vibration isolation table according to the present invention. [2] Other examples of the precision vibration isolation table applied with the present invention. First, the above [1] is described on the basis of a [first embodiment].

### First Embodiment

### 1. Basic Structure of Precision Vibration Isolation Table According to the Present Invention

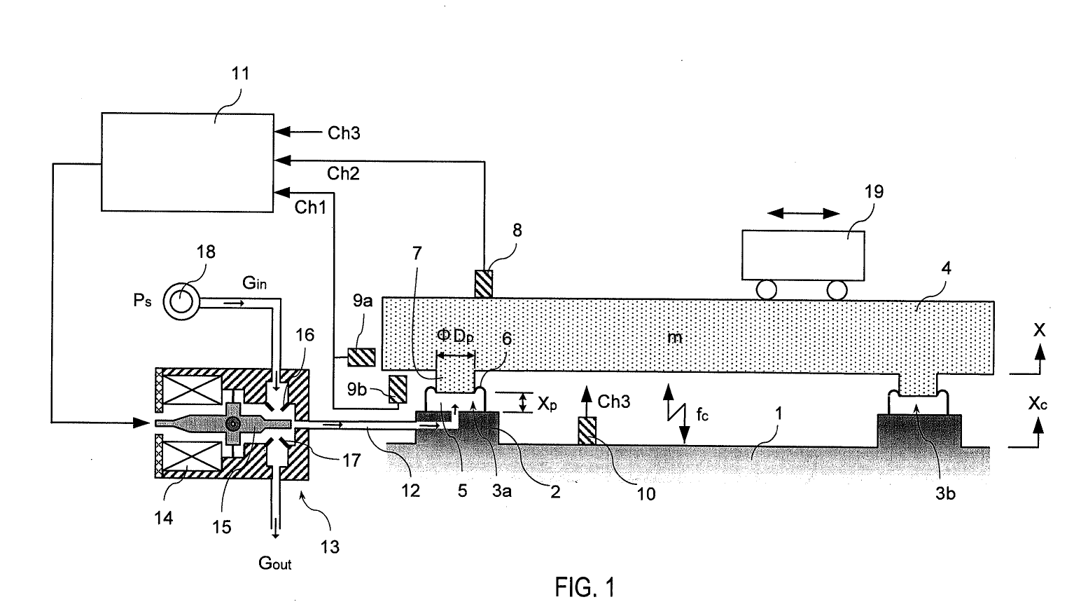

FIG. 1 is a model diagram illustrating an example of an active precision vibration isolation table according to a first embodiment of the present invention. The precision vibration isolation table is used for precision equipment for which a vibration allowable condition to ensure performance is extremely strict, as used for a semiconductor-related manufacturing apparatus such as an exposure system (stepper), or precision measuring equipment such as a scanning electron microscope, or a laser microscope. That is, the precision vibration isolation table of the present embodiment includes: bases 2 installed on a floor surface 1; and a plurality of sets of pneumatic actuators (pneumatic springs) (only 3a and 3b are illustrated) arranged on upper surfaces of the bases 2, and precision equipment (not shown) is mounted on a platen 4 supported by the pneumatic actuators. Any of the pneumatic actuators (hereinafter described with 3a) includes: an air chamber 5 (inside of air spring) inside which high pressure air is filled: and a piston 7 that is inserted inside an upper part of the air chamber through a diaphragm 6 and supports the platen 4. In the active vibration isolation table, an actuator for controlling horizontal X and Y directions is typically arranged, in addition to the actuator for controlling a horizontal Z direction, in order to freely control a six-degree-of-freedom attitude and vibration; however, in the model diagram 1, the actuator for the vertical support is only illustrated.

Reference numerals 8, 9a, and 9b represent an acceleration sensor, and displacement sensors for detecting vertical and horizontal accelerations of the platen 4, and detecting relative displacements of the platen 4 relative to the floor surface 1, respectively. Reference numeral 10 represents an acceleration sensor for detecting an acceleration of the floor surface 1 (fundamental vibrational state). Output signals from the respective sensors are inputted to a controller 11 (control means). The air chamber 5 is connected, through with a tube 12, a servo valve 13 controlled by the controller 11. As the servo valve 13 (flow rate control valve) in the present embodiment, a nozzle flapper type electropneumatic transducer having high responsiveness is used. That is, it is configured such that a flapper 15 integrated with an armature performs swing motion by excitation of an electromagnet 13 to continuously adjust opening levels between an air intake side nozzle 16 and the flapper 15 and between an exhaust side nozzle 17 and the flapper 15. Reference numeral 18 represents an air intake side supply source, and 19 a positioning stage mounted on the vibration isolation table. In the following, effects of the present invention as a vibration isolator are clarified by means of a theoretical analysis.

### 2. Theoretical Analysis of Pneumatic Actuator

2-1. Basic Equations

First, an example of a result of the theoretical analysis of the pneumatic actuator (pneumatic spring) according to the present invention is described in comparison with a conventional example. An output displacement x, a velocity u, and an air chamber pressure Pₐ of the pneumatic actuator can be obtained by simultaneously solving motion equations (Equations 3 and 4) given below and an energy equation (Equation 5) representing a thermodynamic equilibrium condition of the actuator air chamber:

$$\begin{matrix}\frac{d x}{d t} = u & Equation 3 \\ \frac{d u}{d t} = \frac{( {P}_{a} - {P}_{0} ) {A}_{P}}{m} - g - \frac{c}{m} \frac{d x}{d t} & Equation 4 \\ \frac{d {P}_{a}}{d t} = \frac{κ R}{{V}_{a}} ( {T}_{s} {G}_{in} - {T}_{a} {G}_{out} ) - \frac{κ {P}_{a}}{{V}_{a}} \frac{d {V}_{a}}{d t} & Equation 5\end{matrix}$$

In the above equations, and equations (Equations 6 to 9) given below, Aₚ represents a piston area, Pₛ a supply source pressure, P₀ an exhaust side pressure, ρₛ a supply source gas density, m a mass, g a gravitational acceleration, c a viscous damping coefficient, Vₐ an air chamber volume, κ a specific heat ratio, R a gas constant, Tₛ a gas temperature of the supply source, and Tₐ a gas temperature inside the air chamber.

A mass flow rate Gᵢₙ of gas flowing into the air chamber from the supply source side, and mass flow rate Gₒᵤₜ of the gas flowing out from the air chamber to an atmosphere side can be obtained by the following expressions (Equations 6 and 7):

Gᵢₙ={a₀−K_{P}[(x−x_{c})−x₀]}Qₐ(Pₛ, Pₐ) Equation 6

Gₒᵤₜ={a₀+K_{P}[(x−x_{c})−x₀]}Qₐ(Pₐ, P₀) Equation 7

As the servo valve for adjusting the gas flow rate, the nozzle flapper type (13 in FIG. 1) is used. a₀ represents an opening area of the flapper valve at a neutral position, x_{c} represents a displacement of the floor surface on which the actuator is installed, x₀ represents a target value of an actuator displacement, and Kₚ represents a proportional displacement feedback gain. Given that a deviation between an actuator relative displacement x−x_{c} and the target value x₀ is represented by ε=(x−x_{c})−x₀, by applying the proportional displacement feedback, the flow rates Gᵢₙ and Gₒᵤₜ are controlled so as to meet ε→0. The deviation ε is detected from the displacement sensor (9b in FIG. 1). For the mass flow rates of the gas passing through the nozzles of the servo valve, a nozzle equation in isentropic flow of compressible fluid is used. The mass flow rate Gᵢₙ of the gas flowing into the air chamber from the supply source side is given by Equations 8 and 9. Note that Qₐ(Pₛ, Pₐ)=Gᵢₙ/aᵢₙ in Equation 6. Regarding the mass flow rate Gₒᵤₜ of the gas flowing out from the air chamber to the atmosphere side, it is only necessary to modify some parameters in Equations 8 and 9 as Pₛ→Pₐ, Pₐ→P₀, and ρₛ→ρₐ:

$${G}_{in} = {a}_{i n} \sqrt{2 {ρ}_{S} {P}_{S} \frac{κ}{κ - 1} [ {( \frac{{P}_{a}}{{P}_{S}} )}^{\frac{2}{κ}} - {( \frac{{P}_{a}}{{P}_{S}} )}^{\frac{κ + 1}{κ}} ]} \qquad Equation 8$$

### However, if Pₐ/Pₛ<{2/(κ+1)}^{2/(κ-1)}

$${G}_{in} = {a}_{i n} \sqrt{2 {ρ}_{S} {P}_{S} \frac{κ}{κ - 1} {( \frac{2}{κ + 1} )}^{\frac{2}{κ - 1}}} \qquad Equation 9$$

2-2. Vibration isolation performance and analysis result of transient response characteristic

Basic specifications of the pneumatic actuator (pneumatic spring) according to the present invention are listed in Table 1 in comparison with a conventional pneumatic actuator. A significant difference in structure between the present invention and the conventional example is that an outer diameter and gap of the actuator are extremely small, and a supply pressure is high, although a load mass (support load) is the same.

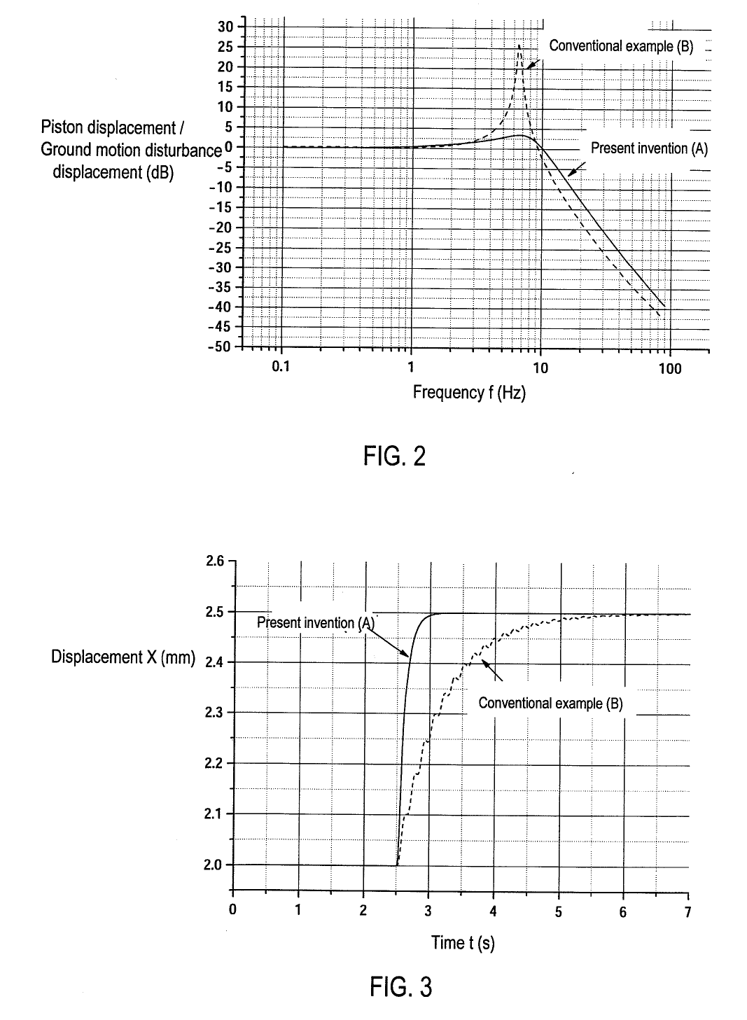

FIG. 2 illustrates the vibration isolation performance with respect to frequency in an example (A) of the present invention in comparison with the conventional example (B). Values of parameters other than those listed in Table 1 are that a gas constant of air R=287 [J/(kg·K)], specific heat ratio κ=1.40, absolute temperature Tₛ=Pₐ=288 K, and viscous damping coefficient c=150 N·s/m. In the example, air is used as working gas of the actuator; however, in the present invention, any type of gas may be used depending on the intended use. In the following, in either case, as a control method for the actuator, the proportional displacement feedback is only applied. Note that the vibration isolation performance is represented by a ratio of a ground motion disturbance displacement x_{c} applied to the actuator installation floor surface to the actuator output displacement x (i.e., x/x_{c}). The conventional example has a sharp resonant peak (max. +25 dB) in the range of f=5 to 8 Hz, whereas the present invention has a gentle convex (approximately +3 dB) in the same frequency range. The vibration isolation performance in a range of f>10 Hz has no significant difference between them.

FIG. 3 illustrates the transient response characteristic in the example (A) of the present invention in comparison with the conventional example. This is for the case where at time t=2.5 s, the target displacement is varied as x₀=2.0→2.5 mm. In the conventional example (B), it takes a time of approximately 3.5 seconds to achieve the target displacement, whereas a settling time in the present invention is 0.5 seconds (⅙ as compared with the conventional example).

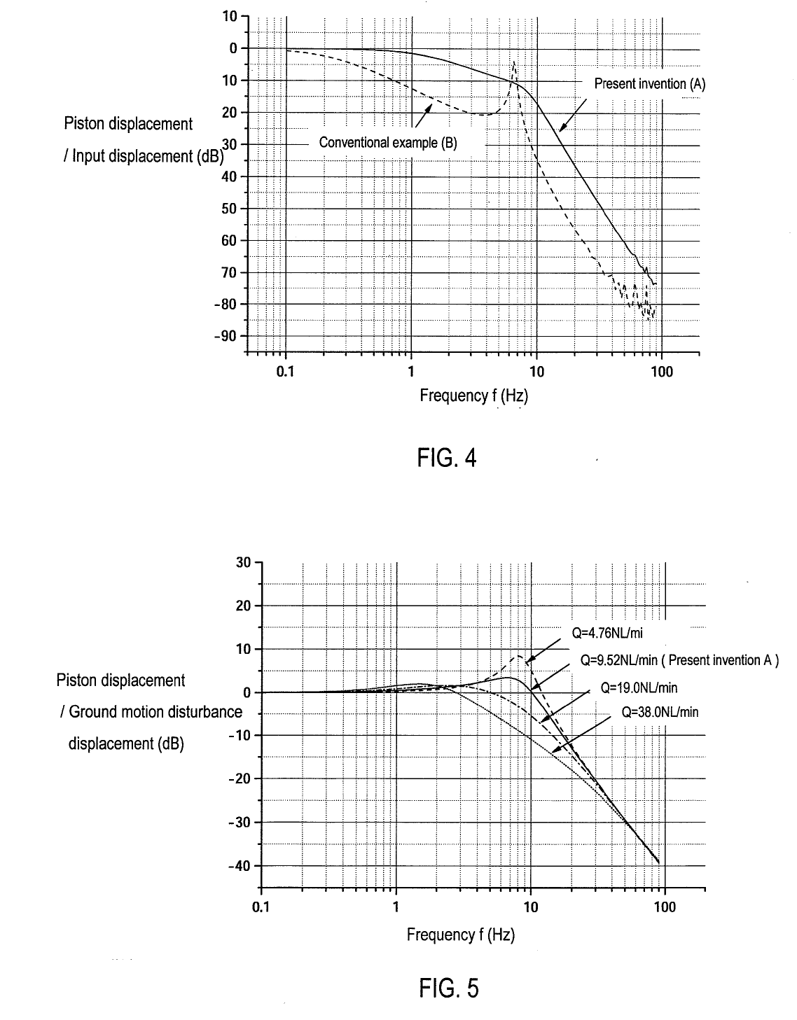

FIG. 4 illustrates a frequency response characteristic in the example (A) of the present invention in comparison with the conventional example (B), which supports the excellent transient response characteristic of the present invention (A) illustrated in FIG. 3. The frequency response characteristic is represented by a ratio of the target input displacement x₀ to the actuator (piston) output displacement x at each frequency (i.e., x/x₀). In the diagram, in the conventional example (B), the ratio starts to fall at around f=0.1 Hz, whereas in the present invention, it remains flat up to around f=1.0 Hz. The present invention has a high responsiveness by 10 to 20 dB in all frequency range as compared with the conventional example.

In summary, as described above, the vibration isolator in the example of the present invention can reduce the transient response characteristic to ⅙ of that of the conventional product with keeping the vibration isolation characteristic almost the same as that of the conventional product. This transient response characteristic (frequency response characteristic) indicates the high vibration control performance for the direct acting disturbance.

TABLE 1

| | | Present | Conventional |
|---|---|---|---|
| | Symbol | invention (A) | example (B) |
| Actuator outer diameter | D_{P} | 30 mm | 96 mm |
| Actuator average gap | Xₚ₀ | 5.0 mm | 18.1 mm |
| Load mass | m | 60 Kg | ← |
| Supply side pressure | Pₛ | 1000 KPa | 320 KPa |
| Exhaust side pressure | P₀ | 101 KPa | ← |
| | | (Atmospheric | |
| | | pressure) | |
| Valve flow rate | Q | 9.52 NL/min | 5.55 NL/min |
| Proportional displacement | G_{P} | 2.0 × 10⁻⁵ m | ← |
| feedback gain | | | |

2-3. Influence of Flow Rate on Vibration Isolation Performance and Transient Response Characteristic

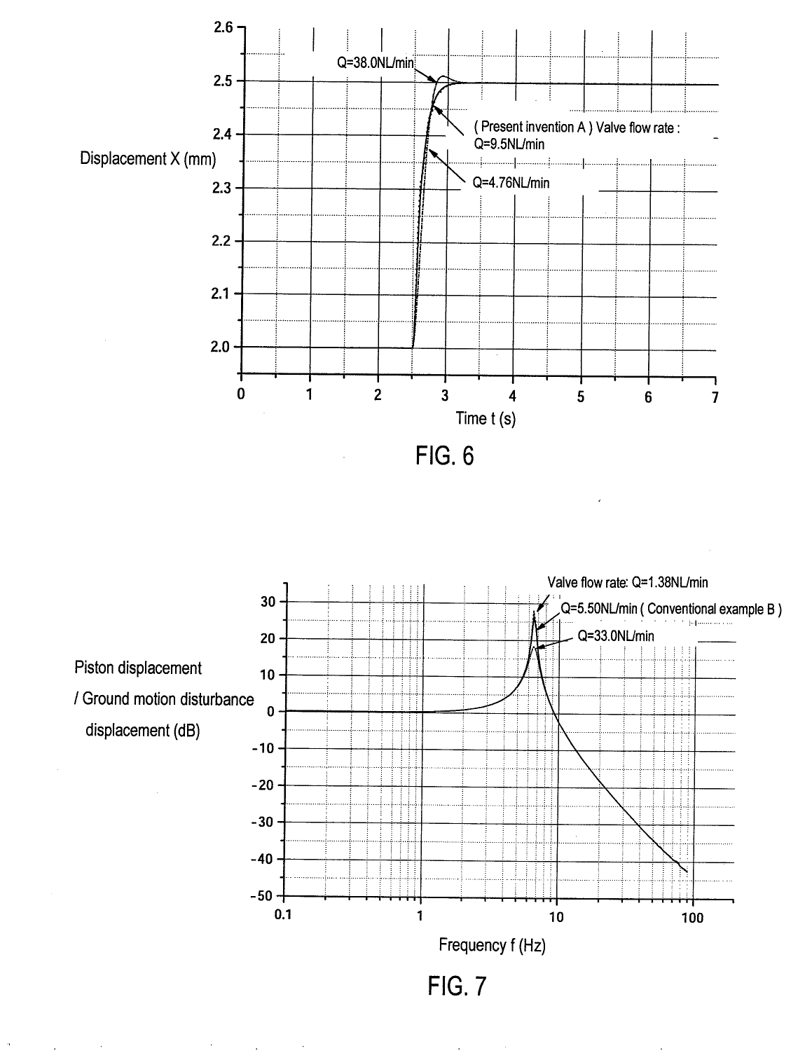

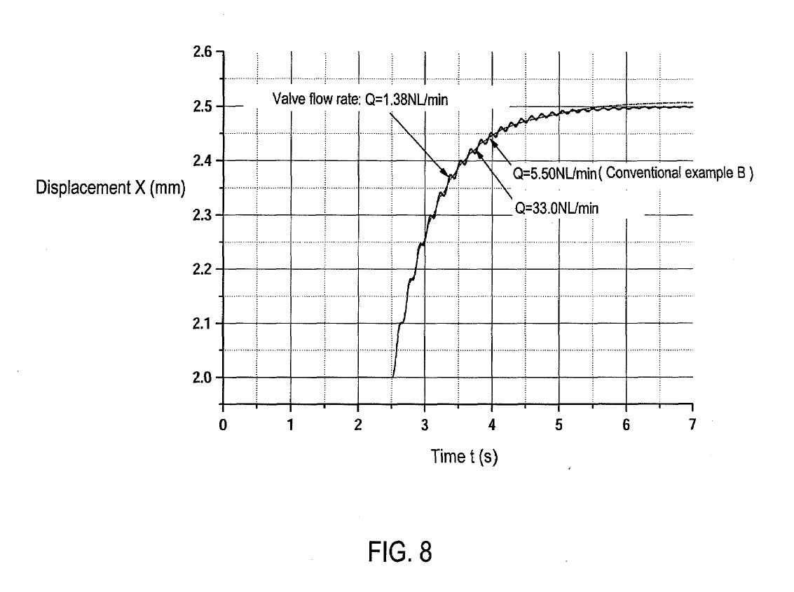

In the specifications of Table 1, the valve flow rate is different between the example (A) of the present invention and the conventional example (B). For this reason, the influence of the valve flow rate on the vibration isolation performance and the transient response characteristic is considered on the basis of the comparison between the example (A) of the present invention and the conventional example (B). The vibration isolation performance in the example (A) of the present invention for the case where only the valve flow rate is varied in the specifications of Table 1 is illustrated in FIG. 5, the transient response characteristic for the case where at the time t=2.5 s, the target displacement is varied as x₀=2.0→2.5 mm is illustrated in FIG. 6. Similarly, for the conventional example (B), the vibration isolation performance, and transient response characteristic are respectively illustrated in FIGS. 7 and 8.

In the case of the example (A) of the present invention, the valve flow rate largely influences the vibration isolation performance. It turns out from graphs in FIG. 5 that as the valve flow rate is increased from Q=4.76 NL/min to 38.0 NL/min, the vibration isolation effect can be obtained down to lower frequencies. However, as indicated by graphs in FIG. 6, the valve flow rate does not significantly influence the transient response characteristic, and even if the flow rate is reduced, the response characteristic is not deteriorated.

In the case of the conventional example (B), as indicated by graphs in FIG. 7, significantly differently from the case of the example (A) of the present invention, the valve flow rate hardly influences the vibration isolation performance, and the increase in flow rate only slightly reduces the resonant peak value. Also, as indicated by graphs in FIG. 8, as the valve flow rate is increased, a high frequency pulsating component is reduced, but there is no large improvement in transient response time.

2-4. About Vibration Isolation Performance of the Present Invention

The excellent response characteristic of the pneumatic actuator according to the present invention can lead to a significant effect if the feedforward is applied to the control system. For example, as described above, when the positioning stage (19 in FIG. 1) mounted on the vibration isolation table moves at high speed, the movement produces yawing and pitching vibration in the structure including the platen, along with the moving direction. A vibrational acceleration associated with the stage behavior or acceleration of floor vibration is detected, and a feedforward signal electrically modeling a transmission path of the vibration is generated to drive the actuator so as to cancel out the vibration. In this case, as the responsiveness of the actuator becomes higher, the vibration control becomes effective to higher frequencies, and therefore the impulsive disturbance including a high frequency component can be reduced.

### 3.0 Theoretical Analysis for Obtaining Dynamic Stiffness

3-1. About Introduction of Concept of Dynamic Stiffness

The above-described analysis results are ones for the case where the example (A) of the present invention and the conventional example (B) were both carried out in the same load condition, and regarding the actuator control method, the proportional displacement feedback with the same gain was only applied. As described above, the vibration isolation and the vibration control performances for equipment can be improved by the selection and device of the control system, such as velocity, acceleration, or pressure feedback or feedforward. However, an “improvement effect level” for the case where the control system is devised as described above consistently largely depends on “the quality of a feature” of the pneumatic actuator that is the controlled object. For this reason, the “feature” of the vibration isolator according to the present invention is evaluated under the following condition in comparison with the conventional example:
(1) Dynamic characteristics (mass, viscosity, spring) of a mounted object on the vibration isolator are not taken into account.
(2) Control such as proportional, velocity, or acceleration feedback is not performed.

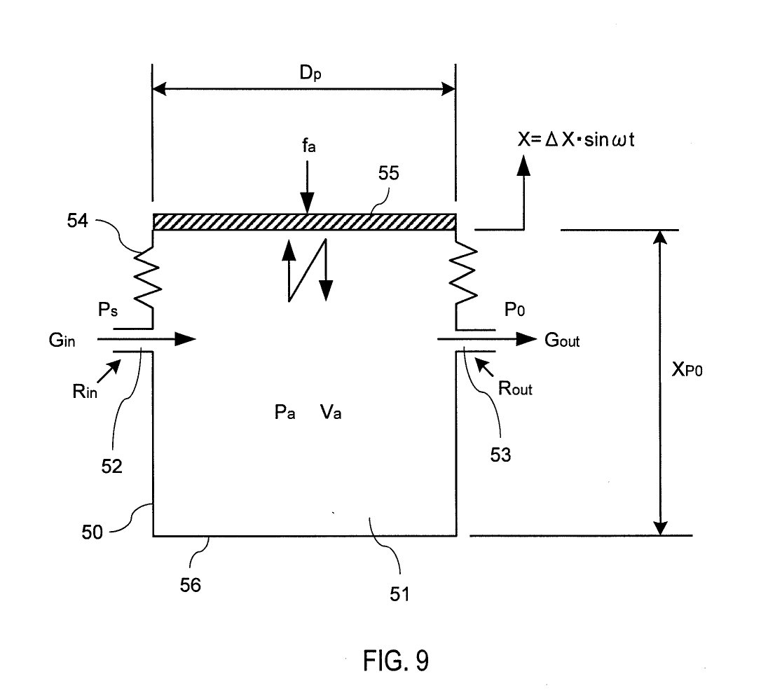

In the following, on the basis of a model diagram in FIG. 9, the energy equation is again solely applied to the air chamber of the pneumatic actuator. Given that dVₐ/dt=Aₚdx/dt in the right side second term of Equation 5, the following expression (Equation 10) can be obtained:

$$\frac{d {P}_{a}}{d t} = \frac{κ R}{{V}_{a}} ( {T}_{s} {G}_{in} - {T}_{a} {G}_{out} ) - \frac{κ {P}_{a} {A}_{p}}{{V}_{a}} \frac{d x}{d t} \qquad Equation 10$$

In the model diagram of FIG. 9, Reference numeral 50 represents a cylinder of the pneumatic actuator, 51 the air chamber, 52 an air intake port, 53 an exhaust port, 54 the diaphragm, 55 the piston (mass is ignored), and 56 a cylinder bottom surface. In the following, we obtain a generated load fₐ in the air chamber 51 for the case where the piston 55 is vertically sine-wave driven under the sine wave condition of x=Δx₀·sin(ωt). Comparing the vibration isolation table in FIG. 1 and the model diagram in FIG. 9 with each other, the air intake port 52 and the exhaust port 53 correspond to the air intake side nozzle 16 of the servo valve, and the exhaust side nozzle 17, respectively.

3-2. Linearization of Energy Equation

In the following, the energy equation is linearized. We assume that temperatures of the gas supply source and the actuator air chamber are constant, i.e., T_{c}=Tₛ=Tₐ. By partially differentiating the right side first term of Equation 10 with respect to an air intake port area aᵢₙ and pressure Pₐ, Equation 11 is derived:

$$\frac{κ R {T}_{c}}{{V}_{a}} ( {G}_{in} - {G}_{out} ) = \frac{κ R {T}_{c}}{{V}_{a}} [ \frac{\partial ( {G}_{in} - {G}_{out} )}{\partial {a}_{in}} Δ {a}_{in} + \frac{\partial ( {G}_{in} - {G}_{out} )}{\partial {P}_{a}} Δ {P}_{a} ] \qquad Equation 11$$

Here, given that Gᵢₙ=aᵢₙQᵢₙ(Pₛ, Pₐ), and Gₒᵤₜ=aₒᵤₜQₒᵤₜ(Pₐ, P₀), Gᵢₙ−Gₒᵤₜ=aᵢₙQᵢₙ−aₒᵤₜQₒᵤₜ=aᵢₙ(Qᵢₙ+Qₒᵤₜ)−aₘₐₓQₒᵤₜ. Also, given that an air intake side resistance is represented by Rᵢₙ, and an exhaust side resistance by Rₒᵤₜ, 1/Rᵢₙ=−∂Gᵢₙ/∂Pₐ, and 1/Rₒᵤₜ=∂Gₒᵤₜ/∂Pₐ. The terms inside the right side brackets of Equation 11 are represented by:

$$\frac{\partial ( {G}_{in} - {G}_{out} )}{\partial {a}_{in}} Δ {a}_{in} + \frac{\partial ( {G}_{in} - {G}_{out} )}{\partial {P}_{a}} Δ {P}_{a} = ( {Q}_{in} + {Q}_{out} ) Δ {a}_{in} - ( \frac{1}{{R}_{in}} + \frac{1}{{R}_{out}} ) Δ {P}_{a} \qquad Equation 12$$

By substituting Equation 12 into Equation 10, the linearized energy equation (Equation 13) can be obtained:

$$\frac{d ( Δ {P}_{a} )}{d t} + \frac{κ {RT}_{c}}{{V}_{a}} ( \frac{1}{{R}_{in}} + \frac{1}{{R}_{out}} ) Δ {P}_{a} = \frac{κ {RT}_{c}}{{V}_{a}} ( {Q}_{in} + {Q}_{out} ) Δ {a}_{in} - \frac{κ {P}_{a}}{{V}_{a}} {A}_{p} \frac{d x}{d t} \qquad Equation 13$$

3-3. Dynamic Stiffness of Pneumatic Actuator

We assume that in Equation 13, the opening level of the flow rate control valve is not varied, but kept constant, i.e., Δaᵢₙ=0. Also, given that the generated load in the air chamber is fₐ=Aₚ·Pₐ, Equation 14 is obtained:

$$\frac{d ( Δ {f}_{a} )}{d t} + \frac{κ {RT}_{c}}{{V}_{a}} ( \frac{1}{{R}_{in}} + \frac{1}{{R}_{out}} ) Δ {f}_{a} = - \frac{κ {P}_{a}}{{V}_{a}} {A}_{p}^{2} \frac{d x}{d t} \qquad Equation 14$$

As is well known, a stiffness k₀ (referred to as a static stiffness) of gas in a closed container can be expressed by the following expression (Equation 15):

$${k}_{0} = \frac{κ {P}_{a}}{{V}_{a}} {A}_{p}^{2} \qquad Equation 15$$

A dynamic stiffness K_{d}(S) of the pneumatic actuator is obtained in consideration of piston displacement by external force being stiff and a sign of the generated load in equilibrium with the external force. Laplace transformation of Equation 14 leads to Equation 16:

$${K}_{d} ( s ) = - \frac{F ( s )}{X ( s )} = \frac{{sk}_{0}}{s + \frac{κ {RT}_{c}}{{V}_{a}} ( \frac{1}{{R}_{in}} + \frac{1}{{R}_{out}} )} \qquad Equation 16$$

Here, given that

$${R}_{a} = 1 / ( \frac{1}{{R}_{in}} + \frac{1}{{R}_{out}} ) , \qquad Equation 17$$

Rₐ represents a parallel sum of supply side and exhaust side fluid resistances of the gas as viewed from the air chamber (inside of the pneumatic spring). Making the dynamic stiffness K_{d}(s) dimensionless results in:

$${K}_{d 0} ( s ) = \frac{{K}_{d} ( s )}{{k}_{0}} = \frac{s}{s + \frac{κ {RT}_{c}}{{V}_{a} {R}_{a}}} \qquad Equation 18$$

A dynamic stiffness parameter γ is defined as follows:

$$γ = \frac{κ {RT}_{c}}{{V}_{a} {R}_{a}} \qquad Equation 19$$

From the above result, it turns out that the pneumatic actuator configured with the dynamic stiffness parameter γ being the same has the same dimensionless dynamic stiffness characteristic.

3-4. Time Constant of Pneumatic Spring

Given that, in Equation 13, there is no volume variation of the pneumatic actuator, and dx/dt=0, Equation 20 holds:

$$\frac{d ( Δ {P}_{a} )}{d t} + \frac{κ {RT}_{c}}{{V}_{a} {R}_{a}} Δ {P}_{a} = \frac{κ {RT}_{c}}{{V}_{a}} ( {Q}_{in} + {Q}_{out} ) Δ {a}_{in} \qquad Equation 20$$

By Laplace transformation of Equation 20 with Δfₐ=Aₚ·ΔPₐ, a transfer function of an infinitesimal variation Δfₐ of the generated load corresponding to an infinitesimal variation Δaᵢₙ of the air intake side opening area of the control valve can be obtained as follows:

$$\begin{matrix}\begin{matrix}G ( s ) = \frac{F ( s )}{{A}_{in} ( s )} \\ = \frac{1}{s + \frac{κ {RT}_{c}}{{V}_{a} {R}_{a}}} \frac{κ {RT}_{c} {A}_{p}}{{V}_{a}} ( {Q}_{in} + {Q}_{out} ) \\ = \frac{{F}_{0}}{{T}_{d} s + 1}\end{matrix} & Equation 21\end{matrix}$$

In Equation 21, F₀=RₐA_{P}(Qᵢₙ+Qₒᵤₜ). If a time constant T_{d} is defined as the following expression (Equation 22), the time constant T_{d} is equal to a reciprocal of the dynamic stiffness parameter γ (Equation 19). The time constant T_{d} represents a degree of response to a pressure variation upon filling of the gas in the closed container. Also, as the time constant T_{d} is decreased, gain and phase margins for a stability limit of the system can be made larger. That is, a sufficiently large feedback gain can be set, and therefore control responsiveness can be improved.

$${T}_{d} = \frac{{V}_{a} {R}_{a}}{κ {RT}_{c}} \qquad Equation 22$$

3-5. Absolute Value and Phase Characteristic of Dynamic Stiffness

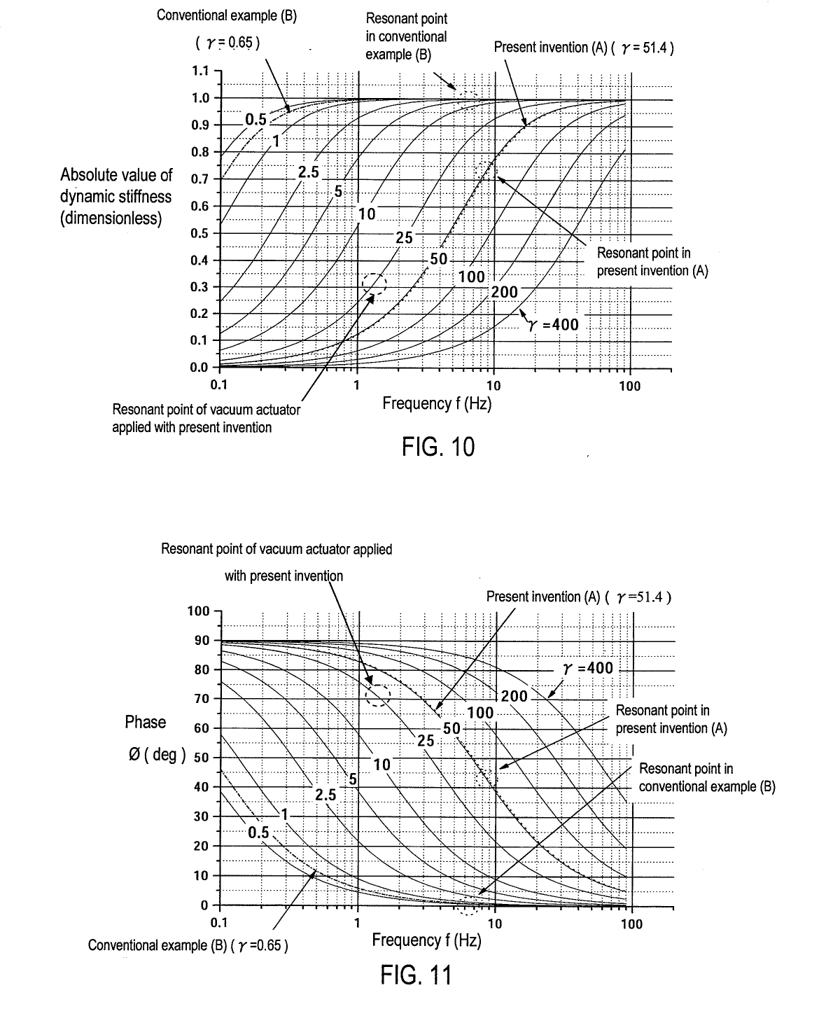

The dynamic stiffness parameter γ (Equation 19) was variously changed to obtain the dimensionless dynamic stiffness (Equation 18) with respect to a frequency. FIG. 10 illustrates an absolute value of the dimensionless dynamic stiffness K_{d0}(jω)=K(j·2πf), and FIG. 11 a phase characteristic.
(1) The absolute value of the dimensionless dynamic stiffness K_{d0}(jω) asymptotically approaches 0 as the frequency f is decreased, i.e., |K_{d0}|0, and to 1 as the frequency is increased, i.e., |K_{d0}|→1.
(2) The phase characteristic of the dimensionless dynamic stiffness K_{d0}(jω) asymptotically approaches 90 degrees as the frequency f is decreased, i.e., φ→90 deg., and to 0 degrees as the frequency f is increased, i.e., φ→0 deg.
(3) As the dynamic stiffness parameter γ is increased, the characteristics of the above (1) and (2) move in parallel to higher frequencies f.

The dynamic stiffness parameter in the example (A) of the present invention, which is obtained from the actuator specifications listed in Table 1, is γ=51.4. In the present example, the opening areas of the air intake side nozzle and the exhaust side nozzle in the neutral state of the flow rate control valve are represented by aₘₐₓ, and the air intake side opening area and the exhaust side opening area at an operating point are respectively set to aᵢₙ=aₘₐₓ×0.645 and aₒᵤₜ=aₘₐₓ×(1−0.645). An operating point pressure of the pneumatic spring at this time is Pₐ=933 kPa. Rᵢₙ and Rₒᵤₜ necessary to obtain the fluid resistance Rₐ in Equation 19 under this condition are Rᵢₙ=7.37×10⁸ (Pa·s/kg) and Rₒᵤₜ=4.75→10⁹ (Pa·s/kg). Similarly, the dynamic stiffness parameter in the conventional example (B) is γ=0.65, and Rᵢₙ and Rₒᵤₜ are Rᵢₙ=1.50×10¹⁰ (Pa·s/kg) and Rₒᵤₜ=1.49×10⁹ (Pa·s/kg). The absolute value and phase characteristic of the dimensionless dynamic stiffness at each γ are illustrated in FIGS. 10 and 11 with a chain line and a dashed dotted line. In the conventional example (B) where the dynamic stiffness parameter γ=0.65, the absolute value of the dimensionless dynamic stiffness asymptotically approaches 1 for the frequency f>1 Hz, i.e., |K_{d0}(jω)|→1. That is, the absolute value of the dynamic stiffness (not dimensionless) obtained from Equation 16, i.e., |K_{d}|, becomes equal to the expression for the static stiffness independent of the frequency, i.e., Equation 15, for f>1 kHz.

$$\vert {K}_{d} \vert = {k}_{0} = \frac{κ {P}_{a}}{{V}_{a}} {A}_{p}^{2} = \frac{κ {P}_{a} {A}_{p}}{{x}_{p 0}} \qquad Equation 23$$

In the above expression (Equation 23), assuming that PₐAₚ cannot be varied under the precondition that the same load [fₐ=(Pₐ−P₀)Aₚ] is supported, in order to achieve the flexible pneumatic spring (improvement of the vibration isolation performance), a piston height x_{P0} should be increased. However, as a result, as described in the above “Problem to be solved by the invention”, the conventional example (B) will have the contradiction relationship, i.e., the responsiveness (vibration control performance) is sacrificed.

In the example (A) of the present invention where the dynamic stiffness parameter γ=51.4, the absolute value of the dimensionless dynamic stiffness meets |K_{d0}(jω)|<1 in a frequency range equal to or less than f=30 to 40. That is, the absolute value of the dynamic stiffness |K_{d}| (not dimensionless) can keep the following condition up to a sufficiently high frequency:

|K_{d}|<k₀ Equation 24

Further, as can be seen from Equations 19 and 20, the reciprocal of the dynamic stiffness parameter γ is the pneumatic spring time constant T_{d}, and as γ is increased, i.e., as the time constant T_{d} is decreased, the response to a pressure variation upon filling of the gas in the container can be made higher. Accordingly, in the present invention (A), in order to achieve the flexible pneumatic spring (small |K_{d}|) and improve the responsiveness (small T_{d}), “the parameter selection is in the same direction”, and does not have the contradiction relationship seen in the conventional example (B).

3-6. Dynamic Stiffness Transition Range

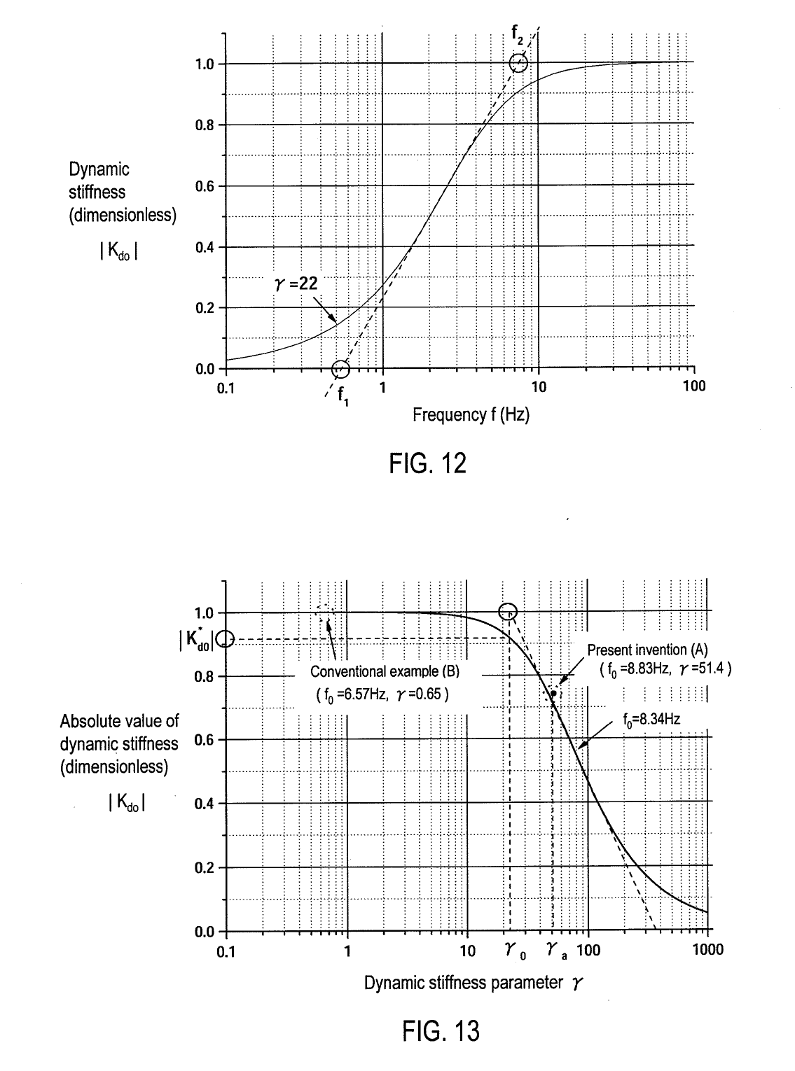

Note that a “dynamic stiffness transition range” refers to a range in which, given that in a pneumatic spring driven in a state where gas is kept flowing from a supply side to an exhaust side during a stationary period, a stiffness determined only depending on a flow path resistance of a flow path communicating from an inside of the pneumatic spring to the supply side and the exhaust side is represented by K_{d}=K_{d1}, and a stiffness determined when all flow paths including the flow path are blocked is represented by K_{d}=K_{d2}, the stiffness transits from the stiffness K_{d1} to the stiffness K_{d2}. Also, note that we define as the “dynamic stiffness transition range” a frequency range in which, because a characteristic curve of a dynamic stiffness with respect to a frequency has a curved surface, a characteristic curve of the dimensionless dynamic stiffness K_{d0}(jω)) is used, and the absolute value and phase characteristic of K_{d0}(jω) are largely varied, as follows: FIG. 12 is a graph illustrating a relationship between the absolute value of the dimensionless dynamic stiffness |K_{d0}| and the frequency f at the dynamic parameter γ=22. Given that values of frequencies at which a tangent at a linear portion of the bilaterally symmetrical graph intersects with |K_{d0}|=0 and |K_{d0}|=1 are respectively represented by f₁ and f₂, the dynamic stiffness transition range is f₁<f<f₂. For example, the dynamic stiffness transition range for the case of the dynamic stiffness parameter γ=22 is 0.55 Hz<f<7.5 Hz. By clearly defining the lower limit f₁ and the upper limit f₂ of the dynamic stiffness transition range, uncertainness arising from the continuous asymptotical approaches of the characteristic curve to 0 and 1, i.e., |K_{d0}|→0 and |K_{d0}|→1, can be swept away, and design specifications by which the present invention is effectively utilized can be specifically determined upon determination of a condition for completing the present invention (described later).

### 4. Condition for Completing the Present Invention

4-1. Setting Condition for Resonant Point f₀

Now, we consider a condition for selecting parameters completing the present invention. Given that a resonant point of the actuator is represented by f₀, a vibration isolation level typically sharply drops in proportion to mω (ω: angular velocity) in a frequency range of f>f₀. For this reason, as the resonant point f₀ is set to a lower frequency, the vibration isolation performance can be obtained in a wider frequency range. However, as described above, the conventional vibration isolation table has a tradeoff relationship between the vibration isolation performance and the vibration control performance, and therefore setting the resonant point f₀ lower results in deterioration of the vibration control performance. If the present invention is applied to set the resonant point f₀ in the “dynamic stiffness transition range”, i.e., to meet f₁<f₀<f₂, the vibration isolation table meeting both of the vibration isolation performance and the vibration control performance can be obtained.

TABLE 2

| | | Present | Conventional |
|---|---|---|---|
| | Symbol | invention (A) | example (B) |
| Pneumatic spring stiffness in | k₀ | 1.85 × 10⁵ N/m | 1.02 × 10⁵ N/m |
| closed state | | | |
| Resonant frequency in closed | f₀ | 8.83 Hz | 6.57 Hz |
| state | | | |
| Dynamic stiffness parameter | γ | 51.4 | 0.65 |
| Absolute value of | \|K_{d0}\| | 0.734 | 1.00 |
| dimensionless dynamic | | | |
| stiffness at resonant | | | |
| frequency f₀ | | | |
| Phase of dimensionless | φ | 42.8 deg | 0.903 deg |
| dynamic stiffness | | | |
| at resonant frequency f₀ | | | |

If the resonant point f₀ is set in a lower frequency range than the dynamic stiffness transition range, the stiffness of the pneumatic spring becomes more flexible, and |K_{d0} | asymptotically approaches 0, i.e., |K_{d0}|→0. Also, the phase characteristic approaches 90 degrees, i.e., φ→+90 deg. However, for practical purposes, in many cases, the resonant point f₀ is preferably set in the “dynamic stiffness transition range”. For example, in the case of the example (A) of the present invention listed in Table 1, if the valve flow rate is increased as Q=9.52→74.1 NL/min (7.8 times), the dynamic stiffness parameter is varied as γ=51.4 →400. If the graph in FIG. 10 is used to linearly approximating the curve for γ=400, the lower limit of the dynamic stiffness transition range will be f₁=9.5 Hz. The resonant point f₀ is independent of the valve flow rate, and therefore f₀<f₁; however, the valve flow rate setting as described above is often not practical also from an economic aspect.

The reason why the dynamic stiffness transition range found out by the present invention suppresses the resonant peak can be explained from the graph of FIG. 11 illustrating the relationship between the phase and the frequency. In a typical case, if an impedance −mω² of a mass having a phase delay of 31 180 deg and that k₀ (static stiffness) of a spring not having a phase delay coincide with each other in their absolute values, i.e., in the case of k₀−mω²=0, a system comes into a resonant state. However, in the example (A) of the present invention, the phase of the impedance K_{d} (dynamic stiffness) of the spring leads by φ=+42.8 deg at the resonant frequency f₀ =8.83 Hz. For this reason, a resonant condition is not met, and therefore even at the frequency f₀, a sharp resonant peak, which is supposed to be present, does not appear. The phase characteristic (FIG. 11) and absolute value (FIG. 10) of the dimensionless dynamic stiffness with respect to the frequency are both obtained from Equation 18, and correspond one-to-one to each other. Accordingly, if the parameters of the actuator (consolidated into the dynamic stiffness parameter γ) are selected so as to meet the phase of the dimensionless dynamic stiffness at the resonant frequency f₀ of the pneumatic spring in the closed state φ>0, i.e., the absolute value |K_{d0}|<1, the resonant peak is suppressed, which can support the completion of the present invention.

As a result of application of the present invention as the vibration isolation table in various conditions, if the dynamic stiffness parameter γ is selected so as to meet the absolute value |K_{d0}|<0.90 at the resonant frequency f₀, an effect of the present invention is further remarkable, as compared with the conventional vibration isolator. Further, if the dynamic stiffness parameter γ is selected so as to meet the absolute value |K_{d0}|<0.80, the vibration isolation table keeping the vibration isolation performance and vibration control performance both in the best conditions can be provided.

4-2. Condition for Setting Lower Limit of Dynamic Stiffness Parameter γ

Regarding the resonant frequency f₀ of the pneumatic spring in the closed state, as described later, the pneumatic spring arranged in the vibration isolator may be directly measured; however, given that the static stiffness of the pneumatic spring obtained from Equation 15 is represented by k₀, and an equivalent mass supported by the one pneumatic spring in the vibration isolator is represented by m, f₀ can be obtained from the following expression. Note that “the pneumatic spring is in the closed state” refers to a state where the supply and exhaust side flow paths are blocked.

$${f}_{0} = \frac{1}{2 π {A}_{p}} \sqrt{\frac{m {V}_{a}}{κ {P}_{a}}} = \frac{1}{2 π} \sqrt{\frac{κ g}{{x}_{p 0}} \frac{{P}_{a}}{( {P}_{a} - {P}_{0} )}} \qquad Equation 25$$

In the above expression, mg=A_{P}(Pₐ−P₀), and Vₐ=x_{P0}A_{P}. As in the example of the present invention, if the supply source pressure Pₛ is sufficiently high, and the operating point pressure meets Pₐ>>P₀, the following expression (Equation 26) holds:

$${f}_{0} ≅ \frac{1}{2 π} \sqrt{\frac{κ g}{{x}_{p 0}}} \qquad Equation 26$$

Accordingly, in the case of the high-pressure driven actuator, f₀ is almost determined only by a piston gap x_{P0}, independently of a piston diameter, or the like. As a result of strictly calculating the example (A) of the present invention (Table 1) with Equation 25, f₀=8.83 Hz as described above, and approximate calculation with Equation 26 (x_{P0}=5.0 mm) results in f₀ =8.34 Hz. Note that, in the example, as the piston gap x_{P0}, if an performance aspect was focused on, x_{P0}=1 to 2 mm was appropriate, whereas if a practical aspect such as a margin upon adjustment of an axial direction height of the isolator was focused on, x_{P0}=6 to 7 mm was appropriate. In the example, as the piston gap x_{P0}, x_{P0}=5.0 mm is selected in consideration of both of the performance aspect and practical aspect.

FIG. 13 is intended to obtain conditions of the dynamic stiffness parameter γ and the absolute value of the dimensionless dynamic stiffness |K_{d0}| under which the present invention can be effectively utilized. We assume that a coordinate of an intersection of a tangent in a curved portion of a graph of the variables |K_{d0} | versus γ and |I K_{d0}|is represented by γ=γ₀, |K_{d0}|at γ=y₀ by |K_{d0}|=|K*_{d0}|, a specific value of the dynamic stiffness parameter of the pneumatic spring by γₐ, and a specific value of the absolute value of the dimensionless dynamic stiffness of the pneumatic spring by |K_{da}|. In this case, it is only necessary to configure the actuator with γₐ>γ₀, or |K_{da}|<|K*_{d0}|. In the example of FIG. 13, if the actuator is configured with γₐ>γ₀=22, or |K_{da}|<|K*_{d0}|=0.91, the vibration isolation table meeting both of the performance aspect and the practical aspect can be provided.

### 5. Method for Experimentally Obtaining Dynamic Stiffness and Dimensionless Dynamic Stiffness

The dynamic stiffness K_{d} and the dimensionless dynamic stiffness K_{d0} of the pneumatic actuator can also be experimentally obtained. In the model diagram of FIG. 9, in a state where any of the piston 55 at the upper surface or cylinder bottom surface 55 is fixed at the floor surface with the pneumatic actuator (pneumatic spring) being removed from the vibration isolator, an output part of a vibration accelerator is brought into close contact with an opposite surface of it. At this time, the piston height x_{P0}, opening levels of the flow rate control valve (air intake side opening area aᵢₙ and exhaust side opening area aₒᵤₜ), and supply source pressure Pₛ are set the same as those in the use condition of the vibration isolator. The cylinder 50, and output part of the vibration accelerator are respectively attached with a pressure sensor for detecting a pressure Pₐ of the air chamber 51, and a displacement sensor for detecting a displacement x. If the vibration accelerator is driven with a frequency being swept, and the generated load fₐ=(Pₐ−P₀)A_{P} is obtained from the detected pressure Pₐ, the piston displacement x and frequency characteristic of a phase with respect to the generated load fₐ, i.e., the dynamic stiffness K_{d}(s) of the pneumatic actuator can be obtained.

As described in Section 3-4, if the time constant T_{d} (Equation 22) is obtained from a time response characteristic or a frequency response characteristic of a pressure (force) variation upon filling the air chamber with gas from the supply side in the state where the flow path communicating from the air chamber to the exhaust side is blocked with the air chamber volume being constant, the dynamic stiffness parameter γ, which is the reciprocal of the time constant T_{d}, can be obtained. With use of this γ value, the dimensionless dynamic stiffness K_{d0} can be calculated from Equation 18. Based on the method described above, even in the case where a structure of the air chamber of the vibration isolation table is complicated, and therefore difficult to perform a theoretical analysis, an application effect of the present invention can be experimentally evaluated with the vibration isolation table being treated as a black box.

[2] Other Examples of Precision Vibration Isolation Table Applied with the Present Invention

### 1. Load Support Type Isolation Vibration Table

1-1. Basic Structure

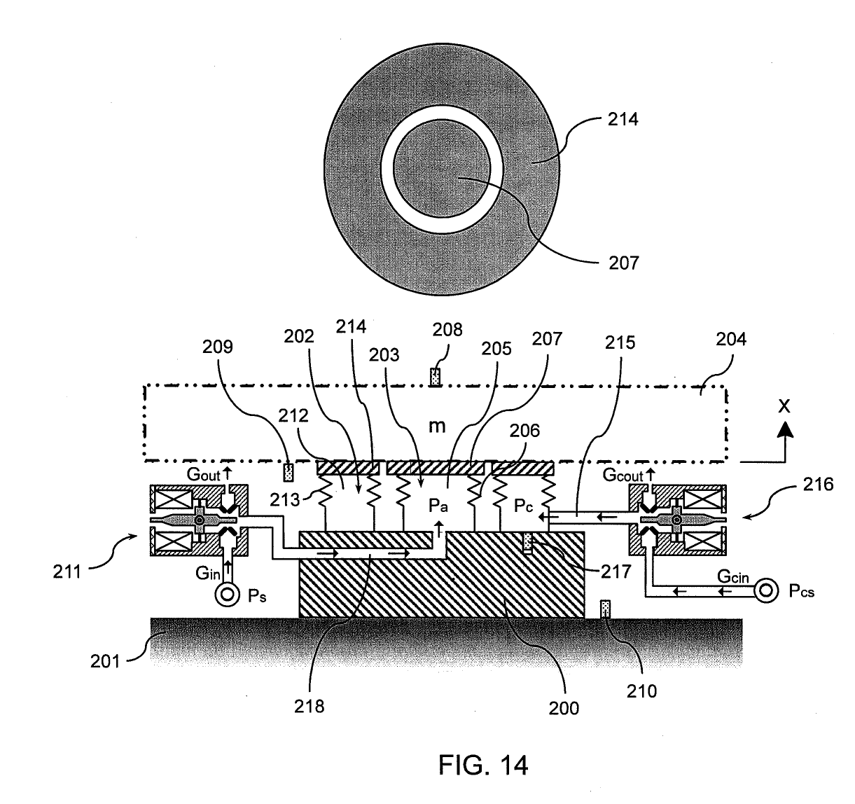

Other examples applied with the present invention are described below. FIG. 14 is a model diagram illustrating an example of an active precision vibration isolation table according to an embodiment 2 of the present invention, which includes the following two pneumatic actuators (1) and (2): (1) A small diameter actuator having a large dynamic stiffness parameter (pneumatic spring). (2) An actuator having a spring stiffness close to zero and supporting most of a load.

By arranging the above two actuators in parallel to support a platen, effects such as an increase in support load, reduction in valve flow rate, and improvement in vibration isolation performance can be obtained.

Reference numeral 200 represents a base installed on a floor surface 201, 202 represents a ring shaped load support actuator (auxiliary actuator) arranged on an upper surface of the base, and in the center, a microactuator 203 (pneumatic spring) is arranged. The two actuators 202 and 203 are used in combination as one set of actuators. In the precision vibration isolation table of the present embodiment, a plurality of the sets of the actuators are arranged on the floor surface 201 to supports a platen 204 (indicated by a dashed two dotted line). The microactuator 203 includes an air chamber A 205, diaphragm 206, and a piston A 207. Reference numerals 208 and 210 represent acceleration sensors, and 209 a displacement sensor. Reference numeral 218 represents a flow path formed in the base 200, and 211 a servo valve A. The load support actuator 202 includes an air chamber B 212, a diaphragm 213, and a piston B 214. Reference numeral 217 represents a pressure sensor for detecting a pressure of the air chamber B.

(1) Microactuator

A load corresponding to 20% of a total mass m is shared and supported. Simultaneously, the pressure Pₐ of the air chamber A is controlled so as to constantly keep a position of the piston A (position of a platen 204) x at a target valeu x₀, and suppress the ground motion disturbance caused by vibration of the installation floor 201 and the direct acting disturbance inputted from above the platen 204 on the basis of pieces of information from the displacement sensor 209 and two acceleration sensors 208 and 210.

(2) Load Support Actuator

A load corresponding to approximately 80% of the total mass m is shared and supported. Simultaneously, an air intake amount G_{cin} and an exhaust amount G_{cout} of the valve are controlled so as to keep the pressure P_{c} of the air chamber B at a constant value P_{c0} as expressed by Equations 27 and 28 on the basis of information from the pressure sensor 217 even if a position of the piston B x (=position of the piston A) is fluctuated.

G_{cin}={a_{c0}−K_{pc}(P_{c}−P_{c0})}Q_{c}(P_{cs}, P_{c}) Equation 27

G_{cout}={a_{c0}+K_{pc}(P_{c}−P_{c0})}Q_{c}(P_{c}, P₀) Equation 28

By the combination of the two actuators having the roles of the above (1) and (2), the support load of the vibration isolation table can be increased without losing the feature of the present invention described in the first example, i.e., “the excellent vibration isolation performance and vibration control performance can be both achieved”. In an example (Table 3), specifications of the microactuator 203 are the same as those (Table 1) of the invention in the first example.

1-2. Comparison in Performance Between Load Support System and Microactuator Alone

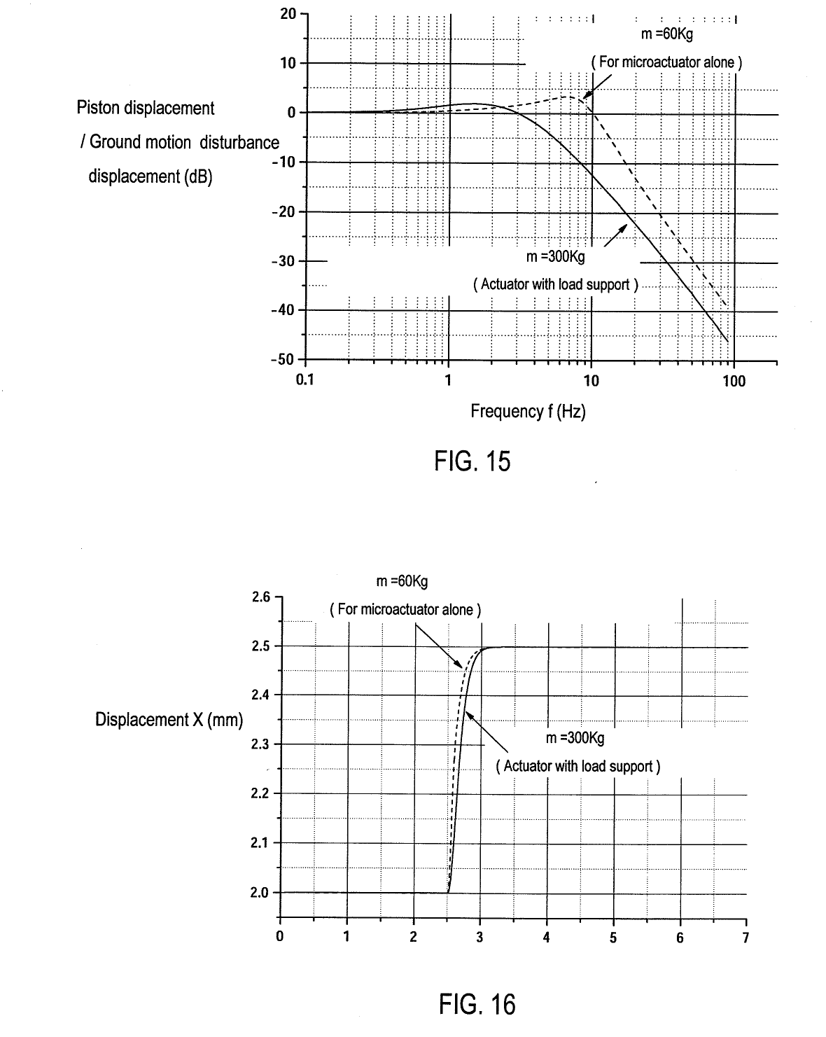

In the present example configured on the basis of the combination of the two actuators, a load of m=300 kg can be supported. As the load is shared, the load support actuator 202 supports m=240 kg, and the microactuator 203 supports m=60 kg (the same as that in the first example). If a ratio of a support load (m=m₀) supported by a whole of the actuators to a support load (m=Δm) supported by the microactuator is defined as a load share ratio ξ of the microactuator, ξ=(Δm/m₀)×100=(60/300)×100=20% in the present example. FIG. 15 is an analysis result in which the vibration isolation performance of the load support type vibration isolation table in the present example is compared with that for the case of the microactuator alone. In the case of the present example, the vibration isolation performance is improved as compared with the case of the microactuator alone, and for example, at f=10 Hz, the vibration isolation performance is improved as 0→−12 dB. The reason why the vibration isolation performance is improved is because a spring stiffness of the load support actuator 202 controlled so as to achieve the constant pressure is K_{c}≈0, and a parallel sum of K_{c} and a dynamic stiffness K_{d} of the microactuator is a spring stiffness of the whole of the actuators.

TABLE 3

| | | Load support system actuator (example of present invention) | | For actuator |
|---|---|---|---|---|
| | Symbol | Load support actuator | Microactuator | alone |
| Actuator outer | Dₚ | Dₚ₁ = 140 mm (Outer diameter) | 30 mm | 67.1 mm |
| diameter | | Dₚ₂ = 50 mm (Inner diameter) | | |
| Actuator average gap | Xₚ₀ | 20 mm | 5.0 mm | ← |
| Load mass | m | 300 Kg | | 300 Kg |
| | | 240 Kg (Share) | 60 Kg (Share) | |
| Supply side pressure | Pₛ | 415 KPa | 1000 KPa | ← |
| Exhaust side pressure | P₀ | 101 KPa (Atmospheric pressure) | ← | ← |
| Valve flow rate | Q | 0.475 NL/min | 9.52 NL/min | ← |
| Control method | | | Proportional displacement feedback | ← |
| | | | G_{P} = 2.0 × 10⁻⁵ m | |
| | | Pressure control | | |

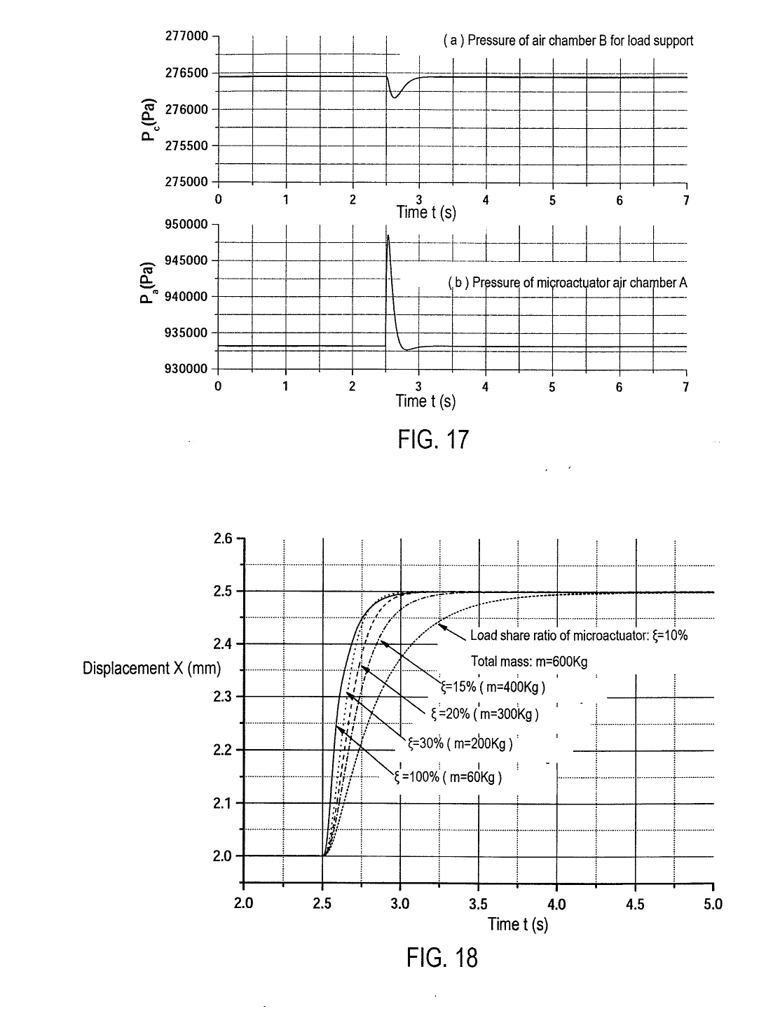

FIG. 16 illustrates a result in which a transient response characteristic of the present example (target displacement x₀=2.0→2.5 mm at 2.5 s) is compared with that for the case of the microactuator alone. Settling times are both approximately 0.5 to 0.6 seconds, and a delay of a response time in the present example with the load share ratio ξ=20% is small. FIG. 17 illustrates pressure characteristics of the air chambers A and B upon transient response in comparison with each other. FIG. 18 is a result in which the transient response characteristics (target displacement x₀=2.0→2.5 mm at 2.5 s) are compared under the condition that the microactuator specifications are not varied, but the load share ratio ξ is varied. That is, the case where the support load is varied in the range of 60 to 600 kg with a pressure receiving area of the load support actuator being only varied is illustrated. From the result, it turns out that up to ξ=approximately 15% is a limit under which the responsiveness is not deteriorated. When ξ is increased as ξ>50%, an economic merit of application of the load support system disappears as compared with the case of the use of two microactuators, and therefore ξ=50% is made an upper limit. Accordingly, in the example, the load share ratio is used with being set in the range of 15%<ξ<50%.

1-3. Comparison in Performance Between Load Support System and Actuator Alone having Large Outer Diameter

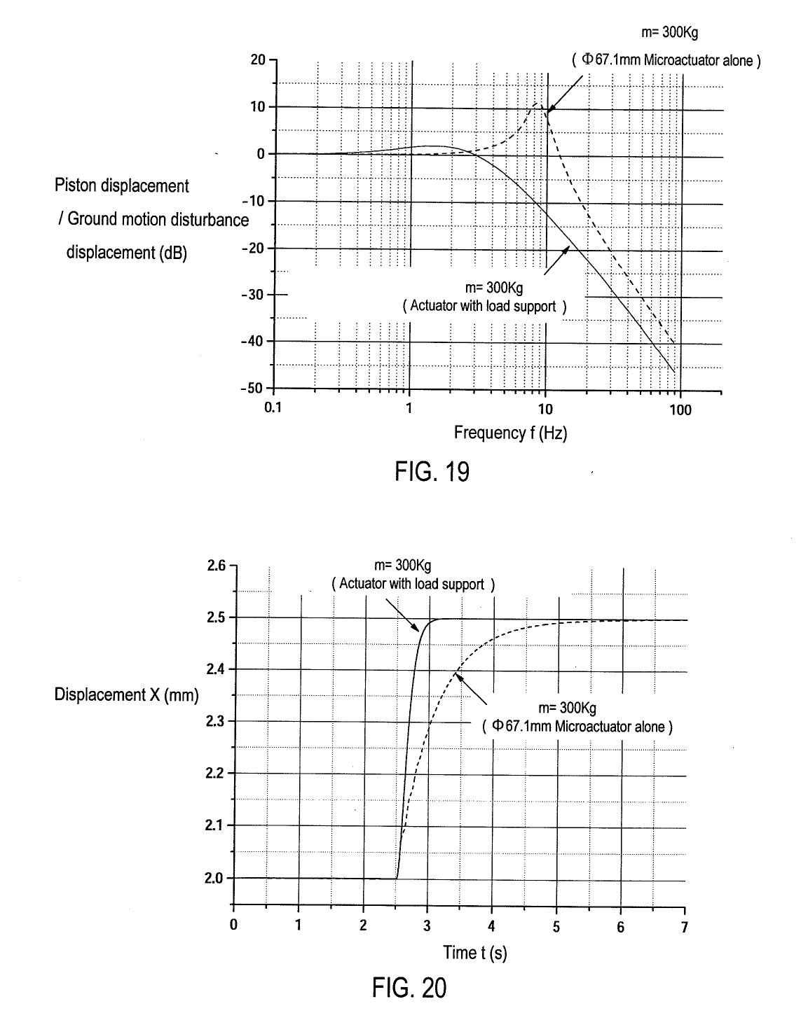

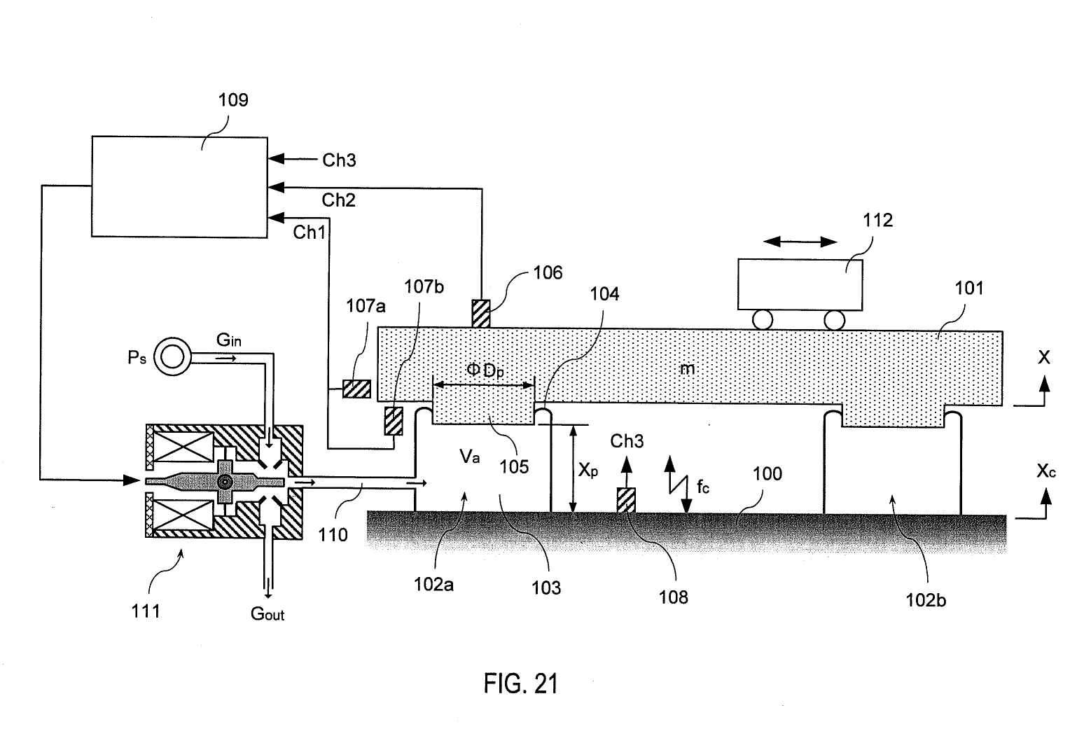

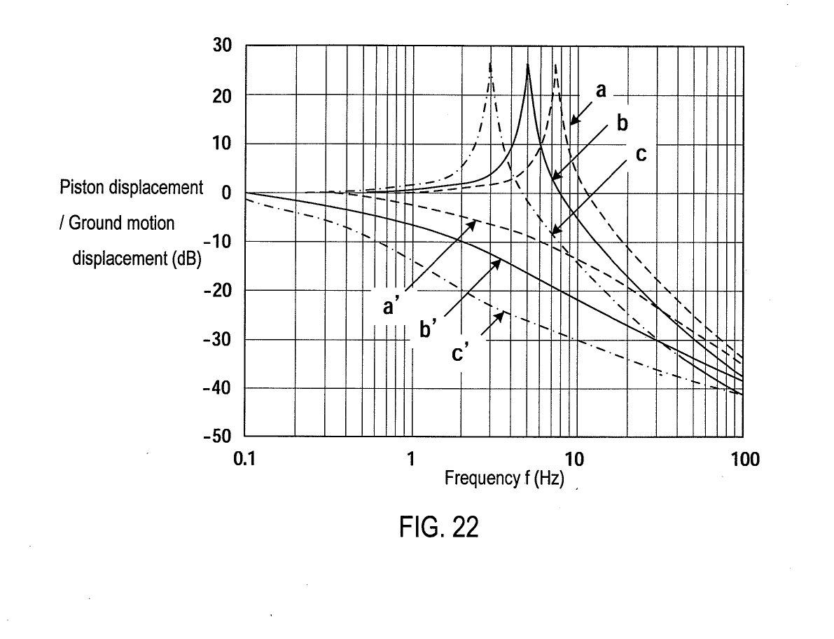

By increasing a piston outer diameter as, for example, Dₚ=30→67.1 mm (5 times in area) with keeping the supply source pressure (Pₛ=100 kPa) the same, the support load can be increased up to m=60→300 kg. FIGS. 19 and 20 are diagrams illustrating comparisons between the above described example of the present invention, and the vibration isolation performance and transient response characteristic of the actuator having the piston outer diameter of Dₚ=67.1 mm. In the case of the actuator alone, the resonant peak is present at around f=8.5 Hz, and the vibration isolation performance and the transient response characteristic are clearly deteriorated as compared with the example of the present invention.

### 2. Configuration of Actuator Applicable for Load Support Purpose

As the load support actuator (auxiliary actuator) applicable to the present invention, for example, a vacuum actuator utilizing vacuum pressure equal to or less than atmospheric pressure may be used. As expressed by Equation 15, the spring stiffness k₀ of the pneumatic actuator is proportional to the pressure Pₐ, and therefore if the vacuum actuator using lower vacuum pressure as an operating point is used, a spring stiffness can be made sufficiently small. In this case, electronic control may be performed so as to make the vacuum pressure constant, or alternatively even if the control is not performed, it is only necessary to keep an inside of an air chamber (vacuum chamber) at a sufficiently low vacuum pressure (not shown).

In addition, as the load support actuator, a magnetic control bearing, a linear motor, a static pressure control gas bearing, or the like that can adjust a stiffness to any value in a range from positive to negative with electronic control can be applied (not shown). In order to simplify a configuration of an entire precision vibration isolation table, one load support actuator may be shared with a plurality of microactuators (pneumatic springs) (not shown).

### 3. Other Control Methods for Load Support Actuator

As a control method for the load support actuator (auxiliary actuator), not a constant pressure control, but displacement, velocity, or acceleration feedback control may be performed, similarly to the case of the microactuator (pneumatic spring). If, instead of a pressure sensor, an acceleration sensor is used to perform the acceleration feedback control, an acceleration (force) and a pressure are almost equivalent to each other as detected information in a high frequency range, and therefore the same effect as that for the case where the pressure control is performed can be obtained. The valve flow rate is also required to be only a minute flow rate, similarly to the case where the above-described constant pressure control using the pressure sensor is performed. However, the control for retaining a constant position cannot be performed in a steady state only with an acceleration signal, and therefore a plurality of control methods may be combined, for example, “acceleration control+control for keeping a constant pressure”. In this case, even if responsiveness and resolution of pressure detecting means (e.g., pressure reducing valve, regulator, or the like that keeps a constant pressure) are poor, the poor performance of the pressure detecting means in a frequency band equal to or more than a few Hz to 10 Hz can be compensated by the acceleration sensor. In order to compensate the poor performance of the pressure detecting means at lower frequencies, absolute velocity feedback may be applied. Instead of the control for keeping a constant pressure, a moderate gain may be given to perform a position feedback.

### 4. Performance Required for Microactuator of Load Support System Vibration Isolation Table

In the case of the load support system vibration isolation table, as described above, the vibration isolation performance can be improved with the responsiveness being kept almost the same, as compared with the case of configuring the vibration isolation table with the microactuator alone. The vibration isolation performance of the load support system with the valve flow rate of Q=9.52 NL/min (table 3) in FIG. 15 is almost the same as the characteristics of the microactuator alone for the case of the valve flow rate of Q=38.0 NL/min in FIG. 15. That is, the fluid resistance Rₐ is inversely proportional to the valve flow rate Q, and therefore by applying the load support to the microactuator, the same performance as that for the case where the dynamic stiff parameter γ (Equation 19) is increased four times (n=38.0/9.52≈4) can be obtained. In the case of the microactuator mounted on the load support system vibration isolation table, it is only necessary to determine design specifications of the microactuator in consideration of the improvement of the performance. In order to evaluate the performance of the load support system vibration isolation table, we here define a dynamic stiffness correction parameter γ* with the following expression:

γ*=n·γ Equation 34

In Equation 34, in the typical case, it is only necessary set n as n≦4. By replacing γ by the dynamic stiffness correction parameter (γ→γ*) to apply the present invention, the design specifications of the microactuator applied to the load support system can be extensively selected (e.g., the outer diameter Dₚ is further increased, and supply source pressure Pₛ is further decreased). As the condition for completing the invention, it is only necessary to obtain a lower limit f*₁ and an upper limit f*₂ of the dynamic stiffness transition range, which are determined from the dynamic stiffness correction parameter γ*, from the graph of FIG. 10, to determine the resonant frequency f₀ of the microactuator (for the load support system), which is determined from a share of a mass. “The entire load support system vibration isolation table” may be considered as “one pneumatic spring” to experimentally obtain the dynamic stiffness K_{d}, the dimensionless dynamic stiffness K_{d0}, the resonant frequency f₀, and the like (see Section 5, Chapter [1]). At this time, the control of the load support actuator is set the same as the use condition in the vibration isolator. From a result of the experiment, it is only necessary to verify the above-described condition for completing the present invention, such as |K_{d0}|<1 at f=f₀ (Hz).

### [3] Supplementary Explanation of the Present Invention

The microactuator applied with the present invention can make the dynamic stiffness parameter γ larger because as the supply source pressure is increased, the piston outer diameter can be made smaller, and therefore obtain the better vibration isolation performance and vibration control performance. However, from a standard for a pressure container, the supply source pressure is often limited to 1 MPa or less. Given that the operating point pressure is represented by Pₐ, and neutral point pressure by Pₘ=(Pₛ−P₀)/2, the operating point pressure Pₐ is preferably set as close to the supply side pressure (e.g., Pₛ=1 MPa) as possible, rather than to the neutral point pressure Pₘ, because the support load of the actuator is fₐ=A_{P}(Pₐ−P₀). As a result of repeated examinations under various use conditions for the vibration isolation table, it turns out that if the operating point pressure Pa is set so as to meet the range of 0.65 Pₛ≦Pₐ≦0.95 Pₛ, there is no practical problem in performing the flow rate control.

Shapes of the air intake and exhaust side nozzles of the servo valve may be asymmetrical, and it is only necessary to determine the shapes of the respective nozzles such that a flow rate characteristic with respect to the opening levels of the nozzles has good linearity around an operating point. Also, as a configuration of the flow rate control valve, for example, spool type three-way valves, four-way valves, or the like may be used in an underlapped configuration (valve through which fluid constantly flows even in an equilibrium state) (not shown).

Regarding the supply pressure to the pneumatic spring (microactuator) in the above-described example of the present invention, the case of using a high pressure source having Pₛ=1 MPa is described. The present invention can be applied even in the case where in contrast, a vacuum pressure equal to or less than an atmospheric pressure is used as the operating point pressure, and a vacuum actuator is driven in a state where gas is kept flowing during a stationary period. In this case, the supply side pressure may be set to a pressure equal to or more than an atmospheric pressure, and the exhaust side pressure may be set to a vacuum pressure, or alternatively the supply source side and the exhaust side are both set to a vacuum pressure. In either case, it is only necessary to use expressions for the dimensionless dynamic stiffness (Equation 18), the dynamic stiffness parameter (Equation 19), and the like to evaluate the effect of application of the present invention.

For example, Pₛand P₀ are respectively set as Pₛ=20 kPa and P₀=10 kPa with the outer diameter, actuator average gap, and supply and exhaust sides being respectively set to Dₚ=96 mm, X_{P0}=18.1 mm, and vacuum pressure. The operating point pressure is set as Pa=10.61 kPa so as to meet the load mass m=67 kg, and the valve flow rate during the stationary period is set to Q=1.94 NL/min. In this case, the fluid resistances are Rᵢₙ=5.301×10¹⁰ (Pa·s/kg) and Rₒᵤₜ=3.055×10⁷ (Pa·s/kg), parallel sum of the fluid resistances is Rₐ=3.053×10⁷ (Pa·s/kg), resonant frequency is f₀=1.5 Hz, and dynamic stiffness parameter is γ=28.9. In the graphs of the absolute value |K_{d0}| (FIG. 10) and phase characteristic φ (FIG. 11) of the dimensionless dynamic stiffness with respect to the frequency f, the resonant point of the above vacuum actuator is plotted. If the vacuum actuator is driven with the gas is kept flowing during the stationary period, the following effects can be obtained:

(1) In the case where the operating point pressure of the actuator is a vacuum pressure, setting values of the nozzle opening areas are inevitably increased because a large volumetric flow is flowed through the control valve with a small pressure difference. For this reason, as compared with the pneumatic actuator used under a normal pressure condition, the fluid resistance Rₐ of the nozzles can be decreased when the same mass flow is flowed through the control valve, and therefore the dynamic stiffness parameter γ and time constant T_{d} can be set larger and smaller, respectively.

(2) The stiffness of the actuator is proportional to a pressure, and therefore as expressed by Equation 17, the actuator using a vacuum pressure as the operating point can make the stiffness and the resonant frequency smaller. From the effects described in the above (1) and (2), for example, in the above-described condition, the resonant frequency is as low as f₀=1.5 Hz; the absolute value of the dimensionless dynamic stiffness at the resonant point is as small as |K_{d0}|=0.32; and the phase lead is as large as phase φ=72 deg. As a result, similarly to the high pressure microactuator, the resonant peak at the resonant point is suppressed, and therefore performance achieving both of excellent vibration isolation performance and vibration control performance (high responsiveness) can be obtained.

What is claimed is:

1. A vibration isolator having a pneumatic spring driven with gas being kept flowing from a supply side to an exhaust side during a stationary period, wherein, given that a stiffness determined only depending on a flow path resistance of a flow path communicating from an inside of the pneumatic spring to the supply side and the exhaust side is represented by K_{d1}, a stiffness determined upon blocking of all flow paths including the flow path is represented by K_{d2}, and a frequency range in which the stiffness transits from the stiffness K_{d1} to the stiffness K_{d2} is referred to as a dynamic stiffness transition range, a resonant frequency determined by the stiffness and a load mass of the pneumatic spring is set in the dynamic stiffness transition range, or a lower frequency range than the dynamic stiffness transition range.

2. The vibration isolator according to claim 1, comprising: the pneumatic spring supporting a vibration isolating object with respect to a base; a flow rate control valve taking the gas from the supply side into the pneumatic spring and exhausting the gas to the exhaust side; a sensor detecting a displacement and/or a vibrational state of the vibration isolating object; and control means that adjusts the flow rate control valve on a basis of information from the sensor to thereby provide gas pressure reducing vibration of the vibration isolating object to the pneumatic spring, wherein, given that a static stiffness and the resonant frequency of the pneumatic spring under the same pressure condition as that of the vibration isolator are represented by k₀ and f₀ (Hz), a dynamic stiffness absolute value of the pneumatic spring as a function of a frequency f (Hz) is represented by |K_{d}(f)|, and a dimensionless dynamic stiffness absolute value is represented by |K_{d0}|=|K_{d}(f)|/k₀, the dimensionless dynamic stiffness absolute value at f=f₀ (Hz) meets |K_{d0}|<1.

3. The vibration isolator according to claim 2, wherein a gas constant of the gas is defined as R [J/(Kg·K)], a specific heat ratio is defined as κ, a circumference ratio is defined as π, an average temperature of the gas is defined as T_{c} (K), an internal volume of the pneumatic spring in a stationary state is defined as Vₐ (m³), a fluid resistance in the flow path communicating from the inside of the pneumatic spring to the supply side and the exhaust side is defined as Rₐ (Pa·s/kg), a dynamic stiffness parameter is defined as γ=κRT_{c}/(VₐRₐ), and a dimensionless dynamic stiffness k_{d0} that is a function of the f and the γ is represented in a complex form and defined as the following expression (Equation 1).
$${K}_{d 0} = \frac{2 π f \cdot j}{2 π f \cdot j + γ} \qquad Equation 1$$

4. The vibration isolator according to claim 2, wherein, given that a time constant obtained from a time response characteristic or a frequency response characteristic of a pressure variation upon filling of the gas in the pneumatic spring from the supply side in a state where the flow path communicating from the inside of the pneumatic spring to the exhaust side is blocked with the internal volume of the pneumatic spring being kept constant is represented by T_{d}, and the dynamic stiffness parameter is represented by γ=1/T_{d}, the dimensionless dynamic stiffness K_{d0} that is the function of the f and the γ is represented in a complex form and defined as the above expression (Equation 1).

5. The vibration isolator according to claim 3, wherein, given that values of frequencies at which a tangent in a curved portion of a graph of a variable |K_{d0}| with respect to a variable f intersects with |K_{d0}|=0 and |K_{d0}|=1 under a condition that the dynamic stiffness parameter γ is constant are respectively represented by f₁ and f₂, f₀ meets f₁<f₀<f₂.

6. The vibration isolator according to claim 4, wherein, given that values of frequencies at which a tangent in a curved portion of a graph of a variable |K_{d0}| with respect to a variable f intersects with |K_{d0}|=0 and |K_{d0}|=1 under a condition that the dynamic stiffness parameter γ is constant are respectively represented by f₁ and f₂, f₀meets f₁<f₀<f₂.

7. The vibration isolator according to claim 1, wherein an auxiliary actuator sharing a load with the pneumatic spring is arranged in parallel with the pneumatic spring, and a load of the vibration isolating object shared and supported by the pneumatic spring is smaller than a load supported by the auxiliary actuator.

8. The vibration isolator according to claim 7, wherein, given that a correction value of a dynamic stiffness parameter γ necessary for the pneumatic spring alone to have a substantially same vibration isolation characteristic as a vibration isolation characteristic upon combination of the pneumatic spring having the dynamic stiffness parameter γ* and the auxiliary actuator is represented by n×γ, the following expression (Equation 2) is defined as a dynamic stiffness correction parameter γ*.
γ*=n·γ Equation 2

9. The vibration isolator according to claim 1, wherein a pressure on the supply side and a pressure on the exhaust side are both set to a vacuum pressure, or the pressure on the supply side is set equal to or more than an atmospheric pressure and the pressure on the exhaust side is set to a vacuum pressure.
